(19) United States
(12) Patent Application Publication
(10) Pub. No.: US 2019/0339380 A1
(43) Pub. Date: Nov. 7, 2019

(54) MULTIPLE-INPUT-MULTIPLE-OUTPUT (MIMO) IMAGING SYSTEMS AND METHODS FOR PERFORMING MASSIVELY PARALLEL COMPUTATION

(71) Applicant: Duke University, Durham, NC (US)

(72) Inventor: Daniel L. Marks, Durham, NC (US)

(21) Appl. No.: 16/310,898

(22) PCT Filed: Jun. 22, 2017
(86) PCT No.: PCT/US17/38878

§ 371 Date: Dec. 18, 2018

Related U.S. Application Data
(60) Provisional application No. 62/353,171, filed on Jun. 22, 2016.

(51) Int. Cl. G01S 13/89; G01S 13/88

(52) U.S. Cl. CPC G01S 13/89; G01S 13/887

(57) ABSTRACT

Multiple-input-multiple-output (MIMO) imaging systems and methods for performing massively parallel computation are disclosed. According to an aspect, a method includes, at a computing device, receiving data from a radar system about a target located within a spatial zone of a receiving antenna and a transmitting antenna. The method also includes approximating the data. The method also includes interpolating the approximation to calculate a result. Further, the method includes forming an image of the data in response to calculating the result. Lastly, the method includes presenting the image to a user via a display.

### CROSS REFERENCE TO RELATED APPLICATION

This application claims the benefit of and priority to U.S. Provisional Patent Application No. 62/353,171, filed Jun. 22, 2016 and titled MULTIPLE-INPUT-MULTIPLE-OUTPUT (MIMO) IMAGING METHODS FOR MASSIVELY PARALLEL COMPUTATION, the disclosure of which is incorporated herein by reference in its entirety.

### STATEMENT AS TO FEDERALLY SPONSORED RESEARCH

This invention was made with the support of the United States government under Federal Grant No. HSHQDC-12-C-00049 awarded by the Department of Homeland Security. The government has certain rights in the invention.

### TECHNICAL FIELD

The presently disclosed subject matter relates to user interaction with computing devices. More particularly, the presently disclosed subject matter relates to multiple-input-multiple-output (MIMO) imaging systems and methods for performing massively parallel computation.

### BACKGROUND

MIMO radars employ a network of transmitters and receivers to image objects or scenes. By distributing the sensors, MIMO radars can image without having to move the transmitters or receivers relative to the object. MIMO radar have become more attractive recently due to advances in electronic integration, signal processing, and antenna designs. Real-time imaging applications such as vehicle navigation, security checkpoint scanning, aerial surveillance, and robotic motion planning benefit from the rapid data acquisition of MIMO radars. However, MIMO radar imaging, especially in indoor environments for which the size of the objects is comparable to the size of the radar system, presents special challenges that are rarely encountered by large-scale radar systems. As the cross-range resolution depends on the angle the antenna array subtends to the target, transmitters and receivers may be located on nearly opposite sides of the target in order to achieve a resolution limited by the illumination wavelength. Furthermore, emerging methods of radar imaging such as frequency diversity use spectrally coded antenna radiation patterns to determine the structure of the target. Standard methods of radar image formation, such as the range migration algorithm, often assume simple, short dipole-like radiation patterns of the antennas rather than complex radiation patterns, and furthermore use a single phase-center approximation where measurements between a distantly located transmitter and receiver are approximated as if these measurements were recorded by a single transceiver placed between the transmitter and receiver. While for a single moving platform, such as an airplane or satellite, these assumptions may be sufficiently accurate, for MIMO radars these assumptions may produce significant error that prevents satisfactory image formation. While image reconstruction algorithms such as backpropagation and direct algebraic inversion can account for these effects, these are often too slow for real-time imaging.

Radar and other coherent imaging systems scatter radiation generated from transmitters from an object of interest, and transduce the scattered radiation into a sampled signal at receivers. Monostatic radars include a single transmitter or receiver that are co-located, and translate and/or rotate relative to the object. Bistatic radars separate the locations of the transmitter and receiver, and either or both are translated and/or rotated relative to the object. It is understood in this context that translation is construed to be either the radar instrument moving or rotating relative to the object or the object moving or rotating relative to the radar, or both moving or rotating relative to each other. The relative motion of the transmitter, receiver, and object is required as radiation must be scattered and received from the object at a diversity of angles in order to acquire spatial features of the object that may be used to form the image. However, as motion requires measurements to be taken serially, the minimum data acquisition interval is the time required for this motion to occur. To reduce the data acquisition time, MIMO radars use multiple transmitters simultaneously radiating energy which is scattered from the object, which are transduced into signals by multiple receivers. The parallel nature of the data acquisition of MIMO radars reduces the time interval required to capture sufficient data to form an image, and furthermore, the object may be illuminated by enough angles without having to move the number of transmitters and receivers at all if a sufficient number of them are used.

In order to understand why other methods of radar inversion is desirable, we existing radar inversion algorithms are examined. Broadly speaking, these can be grouped into two categories, algebraic methods and Fourier-based methods. Algebraic methods use a model of electromagnetic scattering that is very general and can account for nonuniform and distributed layouts of transmitter and receiver antennas as well as variations in the radiation patterns of antennas. The simplest algebraic approach is imaging by backpropagation, where the received signals are summed backwards along the paths from the receiver to the source coherently. Formally, if the linear operation relating the measurements to the target susceptibility is called the forward operator, backpropagation is applying the adjoint of the forward operator to the measurements. This may be further refined by using the forward and adjoint operators to implement a true least-squares or other regularized inverse problem, typically in an iterative reconstruction algorithm. While very general, this method can be quite slow and unsuitable for real-time imaging, and is therefore reserved for situations for which the best possible reconstruction quality must be achieved regardless of the effort. Algebraic methods can be optimized and accelerated for graphics processing hardware, as was achieved on the virtualizer simulation framework, but because of their generality, algebraic methods may fail to take advantage of approximations or shortcuts that could speed the computation without causing appreciable image degradation.

For more rapid computational image formation, methods such as the Fourier range-migration algorithm are used. These methods are extremely fast and efficient. Fourier migration exploits the fact that most radar antennas produce an isotropic-like radiation pattern similar to a short dipole, and that the measurements are taken by a collocated, monostatic transceiver that is sampled at regular spatial and spectral intervals. Because of the high symmetry of this situation, Fourier integrals may be used to model diffraction, and therefore fast Fourier transform methods may be used to accelerate the inversion process. Unfortunately, this method becomes increasingly hard to adapt when these symmetries are broken, for example, when the measurements are no longer monostatic or the antennas are no longer isotropic. While a nearly co-located transmitter and receiver can be approximated as being a monostatic transceiver positioned between the two, i.e. the single-phase center or pseudomonostatic approximation, for large baseline MIMO arrays this approximation is poor, and excluding measurements between distant transmitters and receivers limits the potential reconstruction quality.

Another consideration of a successful radar algorithm is its suitability for implementation in parallel processing hardware. As the limitations of central processing unit (CPU) based computation have become apparent, other models of computing have become more prominent such as that of the parallel processing GPGPU. Other synthetic aperture radar algorithms have already successfully been implemented on GPGPUs, including backprojection methods, Kirchoff migration, range-Doppler methods, Fourier range migration, and range cell migration correction. This relatively new model of computation has been highly successful at speeding image formation algorithms as well as graphics processing, but have its own limitations that must be considered. In particular, while GPGPUs have many compute units that perform hundreds or thousands of floating point computations simultaneously, these compute units usually share a common global memory. The latency and contention for accessing the common memory is a primary consideration when designing an algorithm to be executed rapidly on a GPGPU.

In view of the foregoing, it is desirable to provide improved MIMO imaging systems and methods for performing massively parallel computation.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are MIMO imaging systems and methods for performing massively parallel computation. According to an aspect, a method includes receiving, at a computing device, data from a radar system about a target located within a spatial zone of a receiving antenna and a transmitting antenna. The method also includes approximating the data. The method also includes interpolating the approximation to calculate a result. Further, the method includes forming an image of the data based on the calculated result. The method also includes presenting the image to a user via a display.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. A brief description of the drawings follows.

FIG. 1 is a diagram of the geometry of a transmit and receive antenna, showing the target (a cube), and the surface of stationary points. The coordinate r′ is in the space of the field radiated by the transmit antenna, the coordinate r″ is in the space of the field radiated by the receive antenna, with r being in the space of the target. The transmit and receive antennas have source densities [symbol] and [symbol] respectively.

FIG. 2 is a diagram showing the plane-wave components of the transmit and receive antennas that contribute to the reconstruction in the vicinity of a stationary point rₚ.

FIG. 3 is a diagram of the overall system, showing the layout of the transmit antennas (red) and receive antennas (blue). At the left, an example of the amplitude of the radiation pattern of a receive is shown at three frequencies separated by 90 MHz to demonstrate the rapid variation of radiation pattern with frequency.

FIG. 4 is a diagram of the receiving antenna (left) and the transmitting antenna (right) showing the layout and shape of the radiating apertures, as well as the “zig-zag” line of vias that define the boundary of the cavity.

FIGS. 5A and 5B are images showing a comparison of the least-squares reconstructions of a multi-scatter point target using the Virtualizer (FIG. 5A) and the FAMI reconstruction (FIG. 5B). The dynamic range for plotting is 20 dB.

FIGS. 6A and 6B are images showing a comparison of the least-squares reconstructions of a 1 cm resolution target using the Virtualizer (FIG. 6A) and the FAMI reconstruction (FIG. 6B). The dynamic range for plotting is 20 dB.

FIGS. 7A and 7B are images showing a comparison of the matched-filter reconstructions of the Virtualizer (FIG. 7A) and the FAMI reconstruction (FIG. 7B). The dynamic range for plotting is 20 dB.

FIGS. 8A and 8B are images showing a comparison of the least-squares reconstructions of the Virtualizer (FIG. 8A) and the FAMI reconstruction (FIG. 8B). The dynamic range for plotting is 20 dB.

FIG. 9 is a flow chart of an example method for multiple-input-multiple-output (MIMO) imaging for performing massively parallel computation in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

Unlike conventional single transmitter/receiver monostatic configurations or the separate transmitter/receiver bistatic configurations, MIMO radar is used in configurations where rapid imaging is required or mechanical scanning of the antenna is not feasible. This is because the formation of images from the distributed measurements of MIMO networks is a much more complicated process as the network breaks the typical translational symmetry assumed for most radar algorithms. In particular, algorithms such as the range migration algorithm which assume translational symmetry often are inaccurate or unusable when applied to MIMO radar. Adaptations of the range migration algorithm to bistatic and MIMO radars often make approximations that are increasingly inaccurate as the distance between the transmitter and receiver antennas becomes comparable to the range to the target. This case is especially important when using MIMO radars to image nearby objects with large apertures, such as would occur during security checkpoint scanning or vehicle navigation. A flexible and efficient imaging systems and computational methods are disclosed herein that can form images from MIMO radars. Such systems and methods may be used in instances where the distance between the antennas is comparable to the object range. Systems and methods disclosed herein enable fast, parallelizable mathematical transforms such as the Fast Fourier Transform to be used for efficient image formation. Advantageously, for example, such images can be formed despite the fact that the MIMO radar does not possess the translational symmetry typically assumed by conventional Fourier Transform based imaging methods.

Furthermore, most radars make rather simple assumptions about the frequency dependence of the radiation patterns of their antennas. For example, most antennas such as dipole or parabolic antennas have simple radiation patterns that can be largely characterized by a single phase center which varies little with frequency. Frequency diversity imaging systems (DL. Marks et al., J. Opt. Soc. Am. A., vol 33, pp. 899-912 2016 herein incorporated by reference in its entirety) include antennas that produce highly variable radiation patterns with frequency. The diversity of radiation patterns produced by frequency diverse antennas allows additional spatial resolution to be obtained over that of simple antennas. The price to be paid for the use of frequency diverse antennas is a more complex image formation process. Systems and methods disclosed herein can efficiently form images with MIMO arrays of antennas that have complex radiation patterns. More particularly, systems and methods are disclosed that provide rapid image formation suitable for frequency diverse MIMO radar systems.

Frequency diverse imaging systems include an array of transmitters and receivers. The fields radiated by each transmitter and receiver can be defined by a radiation pattern at each frequency of interest in the bandwidth with which the object is to be interrogated. The radiation from one or more transmitters can be received at a given time by one or more the receivers. The transmitters may transmit on different frequencies or with different codes at a given time so that the signals produced by each may be distinguished at the receivers. A synchronization mechanism between the transmitters and receivers is disclosed that can be used to enable phase coherent detection of the signal. Alternatively, known objects or transponders may be used to relay part of the transmitter radiation to the receiver to enable phase coherent detection.

In particular, general purpose graphic processing units (GPGPUs) such as those produced by NVIDIA or AMD offer orders of magnitude more computational capacity than conventional microprocessor-based computation. GPGPUs may be used in accordance with embodiments and examples disclosed herein. However, GPGPUs may be unsuitable for many kinds of computation, so that only certain computational methods can exploit the massive parallelism of a GPGPU. Systems and methods disclosed herein may be ideally suited to the types of operations that the GPGPUs are intended to accelerate. In particular, the practical speed improvement obtainable by a GPGPU implementation is limited by the memory bandwidth of the GPGPU, and therefore the storage and retrieval of intermediate results during a calculation must be carefully planned to avoid prevent computational capacity from being idled. In order to achieve real-time imaging, MIMO imaging systems and methods disclosed here is able to aggregate results efficiently and exploit the various caching mechanisms of a GPGPU.

Specifically, while GPGPUs have many compute units that perform hundreds or thousands of floating point computations simultaneously, these compute units usually share a common global memory. The latency and contention for accessing the common memory is a primary consideration when designing an algorithm to be executed rapidly on a GPGPU. GPGPUs are equipped with memory caches to mitigate the latency and contention problems, so that designing the algorithm to use cached memory rather than shared global memory can be important to achieving the best performance. Because these caches are frequently designed to accelerate the types of memory access patterns that can occur during graphics processing, an algorithm that uses similar access patterns better avails itself of the cache. More generally, an algorithm suited to parallel processing minimizes the interdependencies between computations so that calculations may be parceled out to many processing units, minimizing the time that processing units are idle waiting for the results of another computation. Systems and methods disclosed herein can achieve these goals. Algorithm can take advantage of all available data and not itself limit the utility of the data. Algorithms implemented by the systems and methods disclosed herein allow flexible placement of transmit and receive antennas, as well as choices of their radiation patterns, while still achieving desired computational performance given the reduced symmetry of the problem.

In accordance with embodiments, systems and methods disclosed herein implement MIMO radar inversion called Fourier Accelerated Multistatic Imaging (FAMI) that does not require a single phase-center approximation, accounts for complex antenna radiation patterns, and produces three-dimensional reconstructions of targets, designed specifically for implementation with highly parallel processors such as GPGPUs so that the inversion may be suitably rapid for real-time imaging on mobile platforms with modest computational capability.

An example benefit of FAMI is that is allows for much of the flexibility of the algebraic inversion methods, that is, nearly arbitrarily placed antennas with complex radiation patterns, but utilizes Fourier transform techniques that enable rapid computation. It may be considered a hybrid of algebraic techniques and Fourier range migration. The primary operation of the Fourier range-migration method that achieves efficient computation is Stolt interpolation, which is the resampling or discrete change-of-variables operation in the Fourier domain. FAMI uses the same approach to achieve efficient computation, but adaptively changes the interpolation function to suit the geometrical configuration of the transmit and receive antennas relative to the target volume. In fact, when the target volume is in the far-field of the entire antenna array baseline and not just the antennas individually, FAMI simplifies to the standard radar ranging image formation method, so that one of the main advantages of FAMI is that interactions between the antennas in the near field of the baseline are accounted for properly. Because of this, FAMI produces correct results whether or not the target is remote or even between antenna pairs, as long as the target remains in the far-field of the antennas individually.

The motivation to develop FAMI is stimulated by two developments: metamaterial structures that have complex frequency responses, and the construction of antennas with complex radiation patterns based on metamaterials. These antennas produce highly structured radiation patterns, unlike the simple ordinary diverging beam of most SAR (synthetic aperture radar) systems, that change rapidly with frequency. Frequency diversity imagers take advantage of these frequency-dependent structured radiation patterns to form images of remote objects, replacing mechanically scanned antennas with faster electronically swept frequency scanning. However, as these radiation patterns are complex, methods that assume high symmetry such as Fourier methods are generally not useful for these imagers, and the algebraic techniques tend to be computationally burdensome. FAMI was developed in part to make frequency diversity imaging more practical and suitable for real-time computation. As one of the intended applications of frequency diversity imagers is checkpoint security scanners, the reconstruction time must be sufficiently fast as to not cause any delays in screening. As frequency diversity and FAMI acquires data and reconstructs images at near video rates, passengers may be screened more quickly.

The presently disclosed subject matter is now described in more detail. The principal model of the radar system is determined using a first-scattering approximation. This model may be defined, in some embodiments, as three steps: (1) radiation from the transmitter, (2) scattering from the object, which in the first-scattering approximation is modeled by a new source of radiation given by the product of the incident field on the object and the object's susceptibility, and (3) measurement of the scattered radiation at a receiver antenna, which is characterized by a phase and amplitude of the received wave, commonly represented as a complex number. As the object is assumed to be described here by an electric susceptibility, the measurement is invariant with respect to exchanging the roles of antennas as the transmitter and receiver. The object is assumed to be placed at a location that is sufficiently far from the antennas as to be in the radiation zone (far field) from the antenna individually, but not necessarily from all the antennas considered as a single aperture. This assumption is not required for systems and methods disclosed herein to work, but it can simplify the subsequent analysis.

In embodiments, the following assumptions may be made in order to simplify the general problem of MIMO radar image formation. While the positions of the transmitter and receiver antennas are not constrained, the entire occupied volume of the target must be in the radiation zone (far-field) of each antenna individually. It is not required for the occupied volume to be in the far-field of the antennas considered collectively, so this assumption applies in many practical situations. In practice this means for all antennas, if d is the extent of an antenna, λ is the wavelength, and z is the range to the target from an antenna, then z>2d²/λ. Furthermore, a surface approximately aligned to the cross-range directions through the occupied volume of the target must be known. Ideally, this surface coincides with the scattering front surface of the object. This may appear to be a serious limitation, but such information may often be obtained by other means, such as structured illumination position sensors or ultrasonic transducers. Alternatively, a combination of antennas may be used, some of which have simple radiation patterns that may be used to locate this surface using conventional ranging techniques, and others which have complex radiation patterns to provide more information about the structure of scatterers on this surface. This surface serves as the focus surface of the image formation, so that point scatterers on this surface are imaged without defocus, and further away from this surface the point scatterers are more defocused. Points that are within the Rayleigh range Δz of the surface for a given antenna array achieve the best focus. For an antenna array with a total baseline length b, Δz=z²λ/b². In the subsequent analysis of FAMI, a diffraction integral is approximated by the method of stationary phase, and the points on the surface are the stationary points at which the diffraction integral is evaluated and the most accurate approximation is obtained.

At a given location which is in the radiation zone of all of the antennas, the field of the antenna may be locally approximated by a plane wave. This is the representation of the radiation zone field, which is a spherical wave with the radiation pattern of the antenna superimposed on it. At a given location in the object, for a given transmitter and receiver antenna pair, there is one plane wave component incident from the transmitter antenna, and only one plane wave component that can be captured by the receiver antenna. Each of these plane waves is described a spatial frequency, which is a vector indicating the periodicity and direction of the plane wave. The spatial frequency that may be captured from the given object location is the sum of the spatial frequencies of the transmitter and receiver radiation pattern spatial frequencies incident on that point. While this result can be applied simple plane waves that are infinite in extent, this result also applies as well to the radiation-zone waves that are incident on the object. This result, which is derived using the method of stationary phase, unfortunately in that form is not suitable for calculation.

In order to apply the method of stationary phase, the stationary point of the phase should be known. The points of stationary phase t=tₚ correspond to the solutions of the equation ∇ϕ=0, which depend on the spatial frequency in the object q. In general, the position of the stationary point can be determined by the position of the object, which is not known before the image is formed. Therefore, it seems that one is unable to proceed with image formation, as information about the object is required to form the image, information that may not be available a priori. The stationary point can be used to determine which spatial frequencies of the radiation patterns of the transmitter and receiver antennas contribute to the imaging of each point in the object. Unlike details in the object itself, which may vary rapidly with position in the object, the spatial frequencies of the transmitter and receiver patterns vary slowly with object position, as the object is in the radiation zone of the antennas. The position of the stationary point only needs to be selected to be near or inside the object volume, and it is not required to place the stationary points directly on the surface of the object or to coincide with any particular object features. Only general information about the object position may be needed, in particular, its exact orientation or position is not required.

An entire volume of stationary points is required to image an object volume. If a dense set of stationary points throughout the object volume of stationary points is used to compute the integral over t, each spatial frequency throughout the three-dimensional volume of the object must be updated. However, it suffices to use a surface of stationary points, rather than a dense set throughout the object volume, that is typically selected to correspond roughly to the coronal plane of the object. This has two advantages. First, only a two-dimensional subset of the spatial frequencies of the object is needed to be used to compute the forward or adjoint operation, significantly reducing how the computational effort scales with the object volume size. Secondly, in general it is much more difficult to determine the position of the stationary point t=tₚ using the equation ∇ϕ=0 from the spatial frequency q than it is to determine the spatial frequency q from the stationary point t=tₚ using. Therefore, it is easier to sum over a surface of stationary points that corresponds to a coronal surface of the object than it is to sum over the spatial frequencies of the object. The Jacobian of the transformation must be modified for the surface rather than volume integration, however, as the Jacobian is slowly varying, approximations to it have a negligible effect on the reconstruction quality.

The complication incurred by summing over the stationary points rather than the spatial frequencies is that the object is specified on a coordinate system with samples uniformly spaced in spatial frequencies, which do not necessarily correspond to uniformly spaced stationary points. As a result, when computing the forward and adjoint, a uniform sampling of the stationary points may result in samples of the spatial frequencies being overcounted or being omitted. The stationary points may be sampled sufficiently densely to ensure that spatial frequencies are not omitted; however, it is likely that some spatial frequencies are then overcounted. As the spatial frequency corresponding to a particular stationary point does not necessarily exactly reside on the lattice of sampled spatial frequencies, the spatial frequency may be interpolated from the surrounding samples on the lattice. An efficient means of interpolation is to use a weighted sum of the adjacent samples of spatial frequency on the lattice to calculate a desired spatial frequency that does not reside on the lattice. This approach may be used to both find the spatial frequency that is not at a lattice point, and to update the spatial frequencies at lattice points corresponding to a particular spatial frequency not at a lattice point.

Methods disclosed herein may be implemented on a digital computer using highly parallelized computation such as a GPGPU. The data corresponding to the radiation patterns of the antennas may be stored in the GPU as textures. The forward and adjoint operations can operate on the three-dimensional (3-D) Fourier transform of the object susceptibility, therefore, this Fourier transform may be stored in a texture as well. Each antenna combination may be computed separately and the results of the forward and/or adjoint summed to parallelize the computation. In addition, the summation over the stationary points may also be divided over parallel computations and added together. By accumulating partial sums of results over subsets of the stationary points, the contention for shared memory between the parallel subprocessors may be reduced as only the partial sums need be combined.

The mathematical operations will now be described in further detail, along with corresponding the implementation and simulation. A description of how FAMI may advantageously be implemented on GPGPU hardware, with the mathematical operations mapped to graphics primitives offered in the GPGPU computing model is provided, along with a specific example based on the NVIDIA Corporation (Santa Clara, Calif.) Compute Unified Device Architecture (CUDA) GPGPU hardware. A simulation of FAMI was also tested in simulation, wherein a known algebraic-based method, the Virtualizer, can be used to compute synthetic measurements from simulated targets, and these measurements are then used by FAMI to reconstruct the target from the measurements. Finally, an analysis of the results was performed to offer conclusions about the performance of FAMI and potential further improvements.

To derive FAMI, a scalar approximation can be used. It may be generalized to fully 3-D vector fields by using the dyadic product of the transmit and receive fields rather than their simple product, a tensor-valued susceptibility of the target, and a vector current density for the antenna sources. However, as these considerations do not change the computation except to add additional degrees of freedom to be accounted for, a scalar solution is sufficient to derive and demonstrate FAMI. Furthermore, the single scattering (or first-Born) approximation is used to derive the scattering from the target. The limitations of the first-Born approximation have been explored.

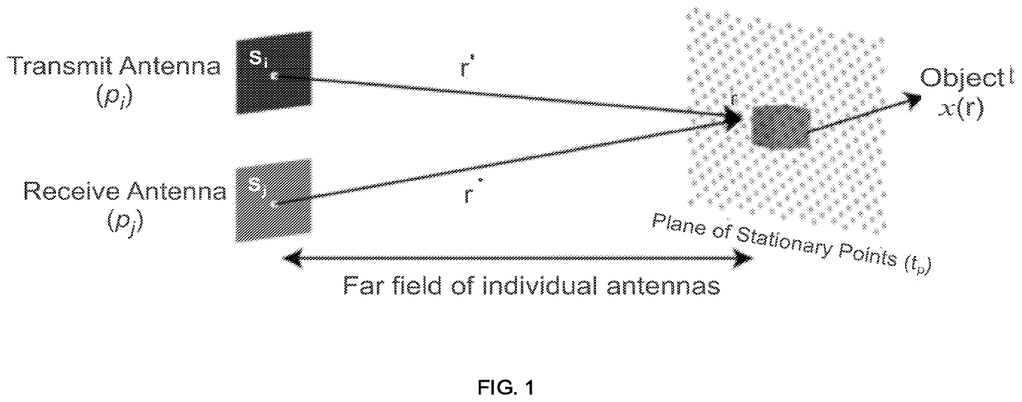

The MIMO imaging system is defined by a number of transmit and receive antennas and a target contained with a target volume, as shown in FIG. 1. The target is assumed to be nonmagnetic and measurements are unchanged upon exchange of a transmit and receive antenna. The transmit and receive antennas are indexed by i and j, respectively. The transmit antennas radiates a field Eᵢ(r;k) into the target volume, and the receive antenna detects a radiated field given by Eⱼ(r;k), with r being the coordinate in the target volume, and k being the illumination spatial frequency. The radiation patterns of the antennas are the far fields of the antennas distant from the source. The antenna field excitation is described by a generally three-dimensional (3-D) source distribution [symbol] ᵢ(r′;k) and [symbol] ⱼ(r″;k), which r′ and r″ being the position in the space of the transmit and receive antennas, respectively, and sᵢ and sⱼ denote the phase center of the antenna radiation patterns. Using convolution with the three-dimensional Green's function of the Helmholtz equation, the field excited by the source distribution is given by

$${E}_{i} ( r ; k ) = {\int }_{V}^{ } {i}_{} ( {r}^{′} ; k ) \frac{exp ( ik \vert r - {s}_{i} - {r}^{′} \vert )}{4 π \vert r - {s}_{i} - {r}^{′} \vert} {d}^{3} {r}^{′} \qquad ( 1 )$$

The volume V corresponds to be volume that contains the target. It is assumed that for all antenna positions r′ and all target positions r, that |r−sᵢ−r′|>d²k/π, so that the far-field approximation may be applied to evaluating Eq. 1. The far-field approximation is

$$\vert r - {s}_{i} - r \vert \approx \vert r - {s}_{i} \vert - \frac{{r}^{′} \cdot ( r - {s}_{i} )}{\vert r - {s}_{i} \vert} ,$$

which applied to Eq. 1 yields:

$${E}_{i} ( r ; k ) = \frac{exp ( ik \vert r - {s}_{i} \vert )}{4 π \vert r - {s}_{i} \vert} \\ {\int }_{V} {ϱ}_{i} ( {r}^{′} ; k ) exp [ - ik \frac{{r}^{′} \cdot ( r - {s}_{i} )}{\vert r - {s}_{i} \vert} ] {d}^{3} {r}^{′} \qquad ( 2 )$$

In the single scattering approximation, the detected power received at antenna j scattered from the object after being illuminated by antenna i is given by

$${P}_{ij} ( k ) = \frac{i 2 {π}^{2}}{{η}_{0} k} {\int }_{V} χ ( r ) {E}_{i} ( r ; k ) {E}_{j} ( r ; k ) {d}^{3} r \qquad ( 3 )$$

where η₀ is the impedance of free space, and χ(r) is the susceptibility of the target to be imaged. A derivation of this equation may be found as Eq. 18 in the scalar approximation. Inserting the far-field approximation of Eq. 2 for the transmit and receive fields as a function of transmit field position r′ and receive field position r″:

$${P}_{ij} ( k ) = \frac{i 2 {π}^{2}}{{η}_{0}^{k}} {\int }_{V} χ ( r ) \frac{exp ( ik \vert r - {s}_{i} \vert )}{4 π \vert r - {s}_{i} \vert} {\int }_{V} {ϱ}_{i} ( {r}^{′} ; k ) exp [ - ik \frac{{r}^{′} \cdot ( r - {s}_{i} )}{\vert r - {s}_{i} \vert} ] {d}^{3} {r}^{′} \frac{exp ( ik \vert r - {s}_{j} \vert )}{4 π \vert r - {s}_{j} \vert} {\int }_{V} {ϱ}_{j} ( {r}^{″} ; k ) exp [ - ik \frac{{r}^{″} \cdot ( r - {s}_{j} )}{\vert r - {s}_{j} \vert} ] {d}^{3} {r}^{″} {d}^{3} r \qquad ( 4 )$$

To express Eq. 4 in the spatial Fourier domain, the 3-D Fourier transform of the source distribution of the antennas is found as a function of spatial frequency q:

$${\tilde{ϱ}}_{i} ( q ; k ) = {\int }_{V} {ϱ}_{i} ( {r}^{′} ; k ) exp ( i {r}^{′} \cdot q ) {d}^{3} {r}^{′} \qquad ( 5 )$$

Inserting the Fourier transforms of the source distributions to simplify the far-field radiation patterns:

$${P}_{ij} ( k ) = \frac{i}{8 {η}_{0} k} {\int }_{V}^{ } χ ( r ) \frac{exp ( ik {\vert r - {s}_{i} \vert}_{\sim} )}{\vert r - {s}_{i} \vert} {i}_{} ( \frac{- k ( r - {s}_{i} )}{\vert r - {s}_{i} \vert} ; k ) \frac{exp ( ik {\vert r - {s}_{j} \vert}_{\sim} )}{\vert r - {s}_{j} \vert} {j}_{} ( \frac{- k ( r - {s}_{j} )}{\vert r - {s}_{j} \vert} ; k ) {d}^{3} r \qquad ( 6 )$$

The phases due to propagation from the phase centers from both antennas to a point in the volume may be combined together:

$${P}_{ij} ( k ) = \frac{i}{8 {η}_{0} k} {\int }_{V}^{ } χ ( r ) \frac{exp [ ik ( \vert r - {s}_{i} \vert + \vert r - {s}_{j} \vert ) ]}{\vert r - {s}_{i} \vert \vert r - {s}_{j} \vert} {}_{ }^{\sim}{i}{}_{ }^{} ( \frac{- k ( r - {s}_{i} )}{\vert r - {s}_{i} \vert} ; {k}^{\sim} ) {j}_{} ( \frac{- k ( r - {s}_{j} )}{\vert r - {s}_{j} \vert} ; k ) {d}^{3} r \qquad ( 7 )$$

To simplify further, the Fourier transform of the object q is found as a function of the spatial frequency q. The position r₀ is the nominal center of the object, and q₀ is the nominal center spatial frequency of the object. In practice, if the volume containing the object is known, r₀ is placed close to the center of the volume, for example, at its centroid. Similarly, q₀ is chosen by examining the Fourier support volume of the target susceptibility that is accessible by a particular antenna and object configuration, and choosing q₀ to be at the centroid of the support volume. The parameters r₀ and q₀ are chosen to minimize the sampling and computational burden, but do not influence the results.

$$χ ( r ) = \frac{1}{{( 2 π )}^{3}} {\int }^{∼} χ ( q ) exp [ - i ( r - {r}_{0} ) \cdot ( q + {q}_{0} ) ] {d}^{3} q \qquad ( 8 )$$

Inserting this Fourier transform into Eq. 7,

$${P}_{ij} ( k ) = \frac{i}{8 {η}_{0} k} {\int }_{V} \frac{1}{{( 2 π )}^{3}} {\int }^{\sim} χ ( q ) exp [ - i ( r - {r}_{0} ) \cdot ( q + {q}_{0} ) ] {d}^{3} q \frac{{exp [ ik ( \vert r - {s}_{i} \vert + \vert r - {s}_{j} \vert )}_{\sim} ]}{\vert r - {s}_{i} \vert \vert r - {s}_{j} \vert} {i}_{} ( \frac{- k ( r - {s}_{i} )}{\vert r - {s}_{i} \vert} ; {k}^{\sim} ) {j}_{} ( \frac{- k ( r - {s}_{j} )}{\vert r - {s}_{j} \vert} ; k ) {d}^{3} r \qquad ( 9 )$$

To further simplify this, the integration order between the r and q variables is reversed:

$${P}_{ij} ( k ) = \frac{i}{64 {π}^{3} {η}_{0} k} {\int }^{∼} χ ( q ) exp [ {ir}_{0} \cdot ( q + {q}_{0} ) ] {\int }_{V} exp [ - ir \cdot ( q + {q}_{0} ) ] \frac{exp [ ik ( \vert r - {s}_{i} \vert + \vert r - {s}_{j} \vert ) ]}{\vert r - {s}_{i} \vert \vert r - {s}_{j} \vert} {}_{ }^{∼}{i}{}_{ }^{} ( \frac{- k ( r - {s}_{i} )}{\vert r - {s}_{i} \vert} ; k {}_{ }^{∼}{j}{}_{ }^{} ) ( \frac{- k ( r - {s}_{j} )}{\vert r - {s}_{j} \vert} ; k ) {d}^{3} r {d}^{3} q \qquad ( 10 )$$

For convenience, the vector t=r−(sᵢ+sⱼ)/2 is defined representing the center position between the transmit antenna i and receive antenna j, as well as their difference in position Δsᵢⱼ=(sⱼ−sᵢ)/2:

$${P}_{ij} ( k ) = \frac{i}{64 {π}^{3} {η}_{0} k} {\int }^{\sim} χ ( q ) exp [ {ir}_{0} \cdot ( q + {q}_{0} ) ] {\int }_{V} exp [ - i ( t + \frac{{s}_{i} + {s}_{j}}{2} ) ( q + {q}_{0} ) ] \frac{exp [ ik ( \vert t - Δ {s}_{ij} \vert + \vert t + Δ {s}_{ij} \vert ) ]}{\vert t - Δ {s}_{ij} \vert \vert t + Δ {s}_{ij} \vert} {}_{}^{\sim}{i}{}_{}^{} ( \frac{- k ( t - Δ {s}_{ij} )}{\vert t - Δ {s}_{ij} \vert} ; {k}^{\sim} ) {j}_{} ( \frac{- k ( t + Δ {s}_{ij} )}{\vert t + Δ {s}_{ij} \vert} , k ) {d}^{3} {td}^{3} q \qquad ( 11 )$$

Examining Eq. 11, there is a rapidly varying propagation phase term:

$$ϕ ( t ) = - ( t + \frac{{s}_{i} + {s}_{j}}{2} ) ( q + {q}_{0} ) + k ( \vert t - Δ {s}_{ij} \vert + \vert t + Δ {s}_{ij} \vert ) \qquad ( 12 )$$

If the other parts of the integrand can be assumed to be slowly spatially varying compared to this phase term, the method of stationary phase may be used to approximate this integral. The order parameter to which the stationary phase approximation is applied to is k as k→∞, however, both the radiation patterns of the antennas and the phase term depend on k. In the far-field of an antenna, the radiation pattern of the antenna, which does not include the propagation phase, varies on a much larger spatial scale than the propagation phase, which varies on a scale given by the wavelength. In practice, this means that the length 1/k is much smaller than the spatial scale over which the antenna radiation patterns [symbol] ᵢ(q;k) vary. Therefore, while the antenna radiation patterns do vary spatially, the variation of the propagation phase term dominates the integral, and the method of stationary phase may be applied.

To O(1/k), the phase propagation term is approximated by a quadratic function in the method of stationary phase, so that the integral in Eq. 11 becomes a multidimensional Gaussian integral. The value of the parts of the integrand that do not rapidly vary are approximated by a constant value at the positions t where ∇φ=0, which are the stationary points. These stationary points are denoted by tₚ. The oscillations caused by the phase propagation term tend to cancel out of the variations in the slowly varying components away from tₚ. The gradient of the propagation phase term is

$$∇ ϕ = - ( q + {q}_{0} ) + k \frac{t - Δ {s}_{ij}}{\vert t - Δ {s}_{ij} \vert} + k \frac{t + Δ {s}_{ij}}{\vert t + Δ {s}_{ij} \vert} \qquad ( 13 )$$

There are in general a continuous curve of stationary points tₚ that satisfy the equation ∇φ=0. Consider one such point tₚ. To find the stationary phase approximation, the quadratic approximation to the phase is found which transforms the integrand into a Gaussian integral. The quadratic approximation to the stationary phase expanded about the stationary point is:

$$ϕ ( t ) = - ( {t}_{p} + \frac{{s}_{i} + {s}_{j}}{2} ) ( q + {q}_{0} ) + k ( \vert {t}_{p} - Δ {s}_{ij} \vert + \vert {t}_{p} + Δ {s}_{ij} \vert ) + \frac{1}{2} {( t - {t}_{p} )}^{T} H ( t - {t}_{p} ) \\ with \\ H = I ( \frac{k}{{t}_{p} - Δ {s}_{ij}} + \frac{k}{{t}_{p} + Δ {s}_{ij}} ) - k \frac{( {t}_{p} - Δ {s}_{ij} ) {( {t}_{p} - Δ {s}_{ij} )}^{T}}{{t}_{p} - Δ {s}_{ij}^{3}} - k \frac{( {t}_{p} + Δ {s}_{ij} ) {( {t}_{p} + Δ {s}_{ij} )}^{T}}{{t}_{p} + Δ {s}_{ij}^{3}} \\ det H = {k}^{3} ( \frac{1}{{t}_{p} - Δ {s}_{ij}} + \frac{1}{{t}_{p} + Δ {s}_{ij}} ) \frac{1}{{t}_{p} - Δ {s}_{ij}} \frac{1}{{t}_{p} + Δ {s}_{ij}} [ 1 - {( \frac{( {t}_{p} - Δ {s}_{ij} ) ( {t}_{p} + Δ {s}_{ij} )}{{t}_{p } - Δ {s}_{ij} {t}_{p} + Δ {s}_{ij}} )}^{2} ] \qquad ( 14 )$$

Inserting this quadratic approximation to φ(t) into Eq. 10 and holding the remainder of the integrand constant at the stationary point, the result is

$${P}_{ij} ( k ) = \frac{i}{64 {π}^{3} {η}_{0} k} {\int }^{∼} χ ( q ) exp [ {ir}_{0} \cdot ( q + {q}_{0} ) ] {\int }_{V} exp [ - i ( {t}_{p} + \frac{{s}_{i} + {s}_{j}}{2} ) ( q + {q}_{0} ) + ik ( \vert {t}_{p} - Δ {s}_{ij} \vert + \vert {t}_{p} + Δ {s}_{ij} \vert ) + \frac{i}{2} {( t - {t}_{p} )}^{T} H ( t - {t}_{p} ) ] {( \vert {t}_{p} - Δ {s}_{ij} \vert \vert {t}_{p} + Δ {s}_{ij} \vert )}^{{- 1}_{∼}} {i}_{} {( \frac{- k ( {t}_{p} - Δ {s}_{ij} )}{\vert {t}_{p} - Δ {s}_{ij} \vert} ; k )}^{- 1} {}_{ }^{∼}{j}{}_{ }^{} ( \frac{- k ( {t}_{p} + Δ {s}_{ij} )}{\vert {t}_{p} + Δ {s}_{ij} \vert} ; k ) {d}^{3} {td}^{3} q \qquad ( 15 )$$

Inserting this quadratic approximation to φ(t) into Eq. 10 and holding the remainder of the integrand constant at the stationary point, the result is

$${P}_{ij} ( k ) = \frac{i}{64 {π}^{3} {η}_{0} k} {\int }^{∼} χ ( q ) exp [ {ir}_{0} \cdot ( q + {q}_{0} ) ] {\int }_{V} exp [ - i ( {t}_{p} + \frac{{s}_{i} + {s}_{j}}{2} ) ( q + {q}_{0} ) + ik ( \vert {t}_{p} - Δ {s}_{ij} \vert + \vert {t}_{p} + Δ {s}_{ij} \vert ) + \frac{i}{2} {( t - {t}_{p} )}^{T} H ( t - {t}_{p} ) ] {( \vert {t}_{p} - Δ {s}_{ij} \vert \vert {t}_{p} + Δ {s}_{ij} \vert )}^{- 1} {}_{}^{\sim}{i}{}_{}^{} ( \frac{- k ( {t}_{p} - Δ {s}_{ij} )}{\vert {t}_{p} - Δ {s}_{ij} \vert} ; k ) {}_{}^{\sim}{j}{}_{}^{} ( \frac{- k ( {t}_{p} + Δ {s}_{ij} )}{\vert {t}_{p} + Δ {s}_{ij} \vert} ; k ) {d}^{3} t {d}^{3} q \qquad ( 15 )$$

The 3-D multidimensional Gaussian integral over t is now evaluated as

$${P}_{ij} ( k ) = \frac{- 1}{8 {π}^{3 / 2} {η}_{0} k} {\int }^{\sim} 𝒳 ( q ) {\vert det H \vert}^{- 1 / 2} exp [ i ( {r}_{0} - {t}_{p} - \frac{{s}_{i} + {s}_{j}}{2} ) ( q + {q}_{0} ) + ik ( \vert {t}_{p} - Δ {s}_{ij} \vert + \vert {t}_{p} + Δ {s}_{ij} \vert ) ] {( \vert {t}_{p} - Δ {s}_{ij} \vert \vert {t}_{p} + Δ {s}_{ij} \vert )}^{- 1} {}^{\sim} {i}_{} ( \frac{- k ( {t}_{p} - Δ {s}_{ij} )}{\vert {t}_{p} - Δ {s}_{ij} \vert} ; {k}^{\sim} ) {j}_{} ( \frac{- k ( {t}_{p} + Δ {s}_{ij} )}{\vert {t}_{p} + Δ {s}_{ij} \vert} ; k ) {d}^{3} q \qquad ( 16 )$$

Unfortunately, to perform the integration of q, the stationary point tₚ must be found by solving ∇φ=0. As mentioned previously, there is in fact a continuous curve of solutions tₚ, and in general solving for tₚ as a function of q is difficult. It is here where physical insight can help solve the problem. The stationary points correspond to the positions in the target where particular plane-wave components of the transmit and receive fields interact. If there are points of the target that are already known, rather than finding the stationary point tₚ based on the Fourier component q, we can parameterize the Fourier component q as a function of the known position tₚ. This way, only the portions of the calculation that are needed to determine the susceptibility in the target volume are performed, rather than over all Fourier components q, as most combinations of these components do not contribute to the scattering in the target volume. The integral of Eq. 16 is reparameterized as a function of tₚ:

$${P}_{ij} ( k ) = \frac{- 1}{8 {π}^{3 / 2} {η}_{0} k} {\int }_{V}^{\sim} χ ( q ) exp [ i ( {r}_{0} - {t}_{p} - \frac{{s}_{i} + {s}_{j}}{2} ) ( q + {q}_{0} ) + ik ( \vert {t}_{p} - Δ {s}_{ij} \vert + \vert {t}_{p} + Δ {s}_{ij} \vert ) ] {\vert det H \vert}^{- 1 / 2} {( \vert {t}_{p} - Δ {s}_{ij} \vert \vert {t}_{p} + Δ {s}_{ij} \vert )}^{- 1} ( \frac{- k ( {t}_{p} - Δ {s}_{ij} )}{\vert {t}_{p} - Δ {s}_{ij} \vert} ; k ) ( \frac{- k ( {t}_{p} + Δ {s}_{ij} )}{\vert {t}_{p} + Δ {s}_{ij} \vert} ; k ) \vert \frac{{\partial }^{3} q}{\partial {t}_{p}^{3}} \vert {d}^{3} {t}_{p} \qquad ( 17 )$$

with q calculated from tₚ as given by Eq. 13:

$$q = k \frac{{t}_{p} - Δ {s}_{ij}}{\vert {t}_{p} - Δ {s}_{ij} \vert} + k \frac{{t}_{p} + Δ {s}_{ij}}{\vert {t}_{p} + Δ {s}_{ij} \vert} - {q}_{0} \qquad ( 18 )$$

However, the calculational effort of Eq. 17 has not been significantly reduced from the model of Eq. 3. To further reduce the effort, consider two stationary points tₚ are near each other and the corresponding two plane-wave components of the transmit and receive antennas that interact at each point given by

$${q}_{i} = \frac{- k ( {t}_{p} - Δ {s}_{ij} )}{\vert {t}_{p} - Δ {s}_{ij} \vert}$$

$$and$$

$${q}_{j} = \frac{- k ( {t}_{p} + Δ {s}_{ij} )}{\vert {t}_{p} + Δ {s}_{ij} \vert}$$

respectively. If the two stationary points are separated in the range direction, as radiation patterns in the far-field tend to vary slowly with range, the same two plane-wave components interact. If the two stationary points are separated in the cross range direction, the radiation patterns of the antennas may vary significantly. Therefore rather than integrating over the entire volume V, one may choose a surface S that is primarily aligned to the cross-range directions. This reduces the dimensionality of the integral from three-dimensional to two-dimensional (2-D), significantly reducing the computational effort. Rewritten as a 2-D integral:

$${P}_{ij} ( k ) = \frac{- 1}{8 {π}^{3 / 2} {η}_{0} k} {{\int }^{∼}}_{S} χ ( q ) exp [ i ( {r}_{0} - {t}_{p} - \frac{{s}_{i} + {s}_{j}}{2} ) ( q + {q}_{0} ) + ik ( \vert {t}_{p} - Δ {s}_{ij} \vert + \vert {t}_{p} + Δ {s}_{ij} \vert ) ] {\vert det H \vert}^{- 1 / 2} {( \vert {t}_{p} - Δ {s}_{ij} \vert \vert {t}_{p} + Δ {s}_{ij} \vert )}^{- 1} {}_{ }^{∼}{i}{}_{ }^{} ( \frac{- k ( {t}_{p} - Δ {s}_{ij} )}{\vert {t}_{p} - Δ {s}_{ij} \vert} ; {k}^{∼} {j}_{} ) ( \frac{- k ( {t}_{p} - Δ {s}_{ij} )}{\vert {t}_{p} + Δ {s}_{ij} \vert} ; k ) \vert \frac{{\partial }^{2} q}{\partial {t}_{p}^{2}} \vert {d}^{2} {t}_{p} \qquad ( 19 )$$

In general, the Jacobian determinant

$$\vert \frac{{\partial }^{2} q}{\partial {t}_{p}^{2}} \vert$$

depends on the exact shape of the surface S. However, as it is not a phase factor, approximation of this determinant do not greatly affect the target reconstruction. To look for a suitable approximation, examine the case of monostatic imaging, so that Δsᵢⱼ=0 and q=−2ktₚ/|tₚ|. In this case

$$\vert \frac{{\partial }^{2} q}{\partial {t}_{p}^{2}} \vert \approx 4 {k}^{2} {\vert {t}_{p} \vert}^{- 2} .$$

To account for the distance from the transmitter and receiver antennas, but approximating the angle between tₚ−Δsᵢⱼ and tₚ+Δsᵢⱼ as small, the determinant may be approximated as

$$\vert \frac{{\partial }^{2} q}{\partial {t}_{p}^{2}} \vert \approx 4 {k}^{2} {\vert ( {t}_{p} - {Δ s}_{ij} ) ( {t}_{p} + {Δ s}_{ij} ) \vert}^{- 1} .$$

This approximation, however, is expected to fail when the transmitter and receiver are on opposite sides of the target. Inserting this approximation to the Jacobian determinant:

$${P}_{ij} ( k ) = \frac{- k}{2 {π}^{3 / 2} {η}_{0}} {\int }_{S}^{\sim} χ ( q ) exp [ i ( {r}_{0} - {t}_{p} - \frac{{s}_{i} + {s}_{j}}{2} ) ( q + {q}_{0} ) + ik ( \vert {t}_{p} - {Δ s}_{ij} \vert + \vert {t}_{p} + {Δ s}_{ij} \vert ) ] \vert det H \vert {( \vert {t}_{p} - {Δ s}_{ij} \vert \vert {t}_{p} + {Δ s}_{ij} \vert )}^{- 2} {}_{}^{\sim}{ϱ}{}_{i}^{} ( \frac{- k ( {t}_{p} - {Δ s}_{ij} )}{\vert {t}_{p} - {Δ s}_{ij} \vert} ; k ) {}_{}^{\sim}{ϱ}{}_{j}^{} ( \frac{- k ( {t}_{p} + {Δ s}_{ij} )}{\vert {t}_{p} + {Δ s}_{ij} \vert} ; k ) {d}^{2} {t}_{p} \qquad ( 20 )$$

Eq. 20 is now in a form that may be efficiently calculated. The surface of stationary points tₚ may be selected to minimize the computational effort as they may be placed in the vicinity of the target. Furthermore, only a two-dimensional surface of points in the three-dimensional target volume are required. Unlike Eq. 3, which integrates a highly oscillatory Green's function and therefore must be sampled at subwavelength intervals to produce an accurate result, Eq. 20 operates in the Fourier space of the target, and therefore the reconstruction may be limited to reduce the computational burden without aliasing. The parameters r₀ and q₀ allow the Fourier transform of the object ^{˜}χ(q) to be stored and processed with the minimum number of samples by offsetting the target in real space and frequency space to a known center position and center spatial frequency at which the target is reconstructed. Finally, operations in the Fourier space of the antenna and target map well onto the geometric operations intrinsic to real-time graphics rendering.

To understand the meaning of the stationary phase approximation in this case, we consider two antennas and a particular stationary point

$${r}_{p} = {t}_{p} + \frac{{s}_{i} + {s}_{j}}{2} ,$$

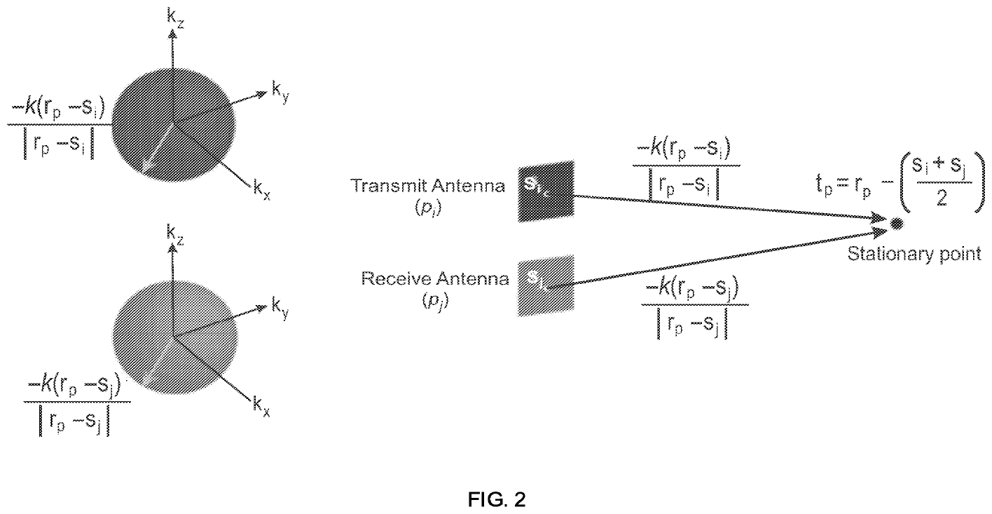

as shown in FIG. 2. As the entire target, including the stationary points in the target volume, are in the far-field of the antennas, only one plane-wave component is incident on the stationary point from each antenna. All of these plane-wave components are on a sphere of k radius from the origin of the Fourier space of the fields. For the transmit antenna, the plane-wave component with the spatial frequency

$$- \frac{k ( {r}_{p} - {s}_{i} )}{\vert {r}_{p} - {s}_{i} \vert}$$

is incident on the target, while the receive antenna only captures the plane-wave component

$$- \frac{k ( {r}_{p} - {s}_{j} )}{\vert {r}_{p} - {s}_{j} \vert}$$

scattered from the target around the region of the stationary point. Therefore only the spatial frequency

$$q = - \frac{k ( {r}_{p} - {s}_{i} )}{\vert {r}_{p} - {s}_{i} \vert} - \frac{k ( {r}_{p} - {s}_{j} )}{\vert {r}_{p} - {s}_{j} \vert}$$

of the object can be probed using this stationary point for this transmit and receive antenna pair.

Eq. 20 is an approximation to Eq. 3 with the stated approximations, however, additional implementation details must be specified to numerically perform the computation. The implementation used in the simulation is described here and provides good accuracy and performance and is suitable for GPGPU computation. Both the forward operator of Eq. 20 to calculate the measurements Pᵢⱼ(k) from the target susceptibility ^{˜}χ(q) and the adjoint is provided which is used to calculate an estimate of ^{˜}χ(q) from Pᵢⱼ(k).

For the implementation, it is assumed that the antennas are two-dimensional, planar antennas with their surfaces normal to the range direction. As the field produced by a three-dimensional antenna can be produced by an equivalent source on a surface, a planar source may always be found that reproduces the three-dimensional antenna field. By transforming the antenna fields to a common coordinate system and storing these transformed fields, the computational effort of transformation need only be performed once for a particular antenna configuration. Rotating the fields to a common coordinate system may be performed by representing the fields as plane waves, and interpolating the uniformly spaced spatial frequencies sampled in the new coordinate system as a function of the old coordinates using a rotation matrix to relate the spatial frequencies of the new and old spatial frequency vectors. It is easiest to leave the phase center of the antenna unchanged and rotate the fields around the phase center. If vector-valued polarized fields are used, the polarization must be rotated at the same time using the same rotation matrix. As it is the plane-wave representation of the radiation pattern that must be stored to apply Eq. 20, the transformed plane-wave representation of the antenna patterns needed for FAMI are directly obtained.

To avoid confusion because of the large number of variables used, Table 1 lists the specified quantities that represent the antennas and target based on the physical parameters of the MIMO radar system, and Table 2 is a table of the quantities that are derived from the quantities of Table 1. The x and y dimensions are the cross-range directions, and the z dimension is the range direction. As Eq. 20 operates on the Fourier transforms of the antenna radiation patterns ^{˜} [symbol] ⱼ(q;k) and target susceptibility ^{˜}χ(q), these are represented by a uniformly sampled, spatially bandlimited function. The antenna radiation patterns are sampled in the cross-range direction at intervals of ΔX and ΔY as the array [symbol] _{nm,ij}, where n and m are the sampled indices −Nₓ/2≤n≤Nₓ/2−1 and −N_{y}/2≤m≤N_{y}/2−1, i is the index of the illumination spatial frequency kᵢ, and j is the index of the antenna. The discrete Fourier transform with respect to n and m is the quantity ^{˜} [symbol] _{nm,i}, with the spatial frequencies in the cross-range direction sampled at intervals of ΔQₓ=1/(NₓΔX) and ΔQ_{y}=1/(N_{y}ΔY). Therefore a particular sample of the antenna's discrete Fourier transform represents a spatial frequency q_{nm,ij}=ΔQₓ\hat{n}x+ΔQ_{y}\hat{m}y+\sqrt{(kᵢ/2π)²−(ΔQₓn)²−(ΔQ_{y}m)²}\hat{z} so that the spatial frequency is on the k-sphere corresponding to radiated waves.

TABLE 1
Definitions of quantities

| Symbol | Units | Description |
|---|---|---|
| χᵢⱼₖ | unitless | Target susceptibility |
| | | samples, indexed by |
| | | cross-range i, j and |
| | | range k position |
| nₓ, n_{y} | count | Number of samples in |
| | | cross-range directions |
| n_{z} | count | Number of samples in |
| | | range direction |
| Δx, Δy | distance | Sample spacing of |
| | | susceptibility in cross- |
| | | range directions |
| Δz | distance | Sample spacing of |
| | | susceptibility in range |
| | | direction |
| Pᵢⱼₖ | power | Measured power |
| | | scattered from object |
| | | from antennas i and j at |
| | | frequency indexed by k |
| Q_{nm,ij} | unitless | Source density at |
| | | frequency i of antenna |
| | | j as a function of |
| | | spatial indices n, m |
| Nₓ, N_{y} | count | Number of samples of |
| | | the source antenna |
| | | density |
| ΔX, ΔY | distance | Sample spacing in |
| | | cross-range direction |
| | | of the antenna source |
| | | density |
| sⱼ | Distance vector | Phase center position |
| | | of antenna j |
| kᵢ | Spatial frequency | List of spatial |
| | | frequencies for which |
| | | data is collected |
| | | indexed by i. |
| tₚ | Distance vector | Positions of stationary |
| | | points |
| r₀ | Distance vector | Center of target |
| | | susceptibility volume |
| q₀ | Spatial frequency vector | Center spatial |
| | | frequency of target |
| | | susceptibility |

TABLE 2
Derived quantities

| Symbol | Units | Description |
|---|---|---|
| χᵢⱼₖ | unitless | Three-dimensional |
| | | discrete Fourier |
| | | transform of χᵢⱼₖ |
| Δqₓ | Spatial frequency | Spatial frequency |
| | | sampling rate of target, |
| | | cross-range |
| | | Δqₓ = 1/(nₓΔx) |
| Δq_{y} | Spatial frequency | Spatial frequency |
| | | sampling rate of target, |
| | | cross-range |
| | | Δq_{y} = 1/(n_{y}Δy) |
| Δq_{z} | Spatial frequency | Spatial frequency |
| | | sampling rate of target |
| | | Δq_{z} = 1/(n_{z}Δz) |
| [symbol] _{nm, ij} | unitless | Two-dimensional |
| | | discrete Fourier |
| | | transform of [symbol] _{nm, ij} |
| | | with respect to indices |
| | | n, m |
| Δ [symbol] ₓ | Spatial frequency | Spatial frequency |
| | | sampling rate of |
| | | antenna field |
| | | Δ [symbol] ₓ = 1/(NₓΔX) |
| Δ [symbol] _{y} | Spatial frequency | Spatial frequency |
| | | sampling rate of |
| | | antenna field |
| | | Δ [symbol] _{y} = 1/(N_{y}ΔY) |
| Δsᵢⱼ | Distance vector | Distance between |
| | | phase centers i and j |
| | | Δsᵢⱼ = (sⱼ − sᵢ)/2 |

Likewise, the target susceptibility is stored as a nₓ×n_{y}×n_{z} three-dimensional array χᵢⱼₖ, which is sampled at regular intervals Δx and Δy in the cross-range direction, and Δz in the range direction, with the indices —nₓ/2≤i≤nₓ/2−1, −n_{y}/2≤j≤n_{y}/2−1, and −n_{z}/2≤k≤n_{z}/2−1. The 3-D discrete Fourier transform of this target susceptibility is stored as ^{˜}χᵢⱼₖ, with the spacing of spatial frequencies in the cross-range direction being Δqₓ=1/(nₓΔx) and Δq_{y}=1/(n_{y}Δy), and in the range direction being Δq_{z}=1/(n_{z}Δz). Therefore a sample of the spatial frequency of the object represents the spatial frequency qᵢⱼₖ=Δqₓîx+Δq_{y}ĵx+Δq_{z}\hat{k}z. Finally, the list of stationary points that correspond to the target surface are given by tₚ.

With the relevant quantities defined, a description of the forward operator is now given. As a precalculation step for both the forward and adjoint operators, the discrete Fourier transform of the source density of the antennas [symbol] _{nm,ij} may be stored as [symbol] _{nm,ij}. The first step of the method is to calculate the 3-D discrete Fourier transform (usually using the Fast Fourier Transform) of the sampled susceptibility χᵢⱼₖ as ^{˜}χᵢⱼₖ. To calculate the measurements P_{ijd} from ^{˜}χᵢⱼₖ, the following sum is performed:

$${P}_{ijd} = {\sum }_{{t}_{p} ; {k}_{d}} \frac{- {k}_{d ∼}}{2 {π}^{3 / 2} {η}_{0}} {χ ( q )}^{∼} {i}_{} ( \frac{- {k}_{d} ( {t}_{p} - Δ {s}_{ij} )}{\vert {t}_{p} - Δ {s}_{ij} \vert} ; {k }^{∼} {j}_{} ) ( \frac{- {k}_{d} ( {t}_{p} + Δ {s}_{ij} )}{\vert {t}_{p} + Δ {s}_{ij} \vert} ; k ) exp [ i ( {r}_{0} - {t}_{p} - \frac{{s}_{i} + {s}_{j}}{2} ) \cdot ( q + {q}_{0} ) + {ik}_{d} ( \vert {t}_{p} - Δ {s}_{ij} \vert + \vert {t}_{p} + Δ {s}_{ij} \vert ) ] {\vert det H \vert}^{- 1 / 2} {( \vert {t}_{p} - Δ {s}_{ij} \vert \vert {t}_{p} + Δ {s}_{ij} \vert )}^{- 2} with q = {k}_{d} \frac{{t}_{p} - Δ {s}_{ij}}{- {t}_{p} - Δ {s}_{ij} -} + {k}_{d} \frac{{t}_{p} + Δ {s}_{ij}}{- {t}_{p} + Δ {s}_{ij} -} - {q}_{0} \qquad ( 21 )$$

The sum of Eq. 21 is performed over all stationary points and frequencies. One complicating factor is that the spatial frequencies q on which the susceptibility ^{˜}χ(q) is sampled do not generally correspond to known samples, rather these are in between known samples. Therefore a method of interpolation is needed to estimate the desired samples from the known samples, for example, nearest neighbor or trilinear interpolation. The indices of the spatial frequencies of the sampled Fourier transform ^{˜}χᵢⱼₖ are given by i=(q·\hat{x})/Δqₓ, j=(q·ŷ)/Δq_{y}, and k=(q·\hat{z})/Δq_{z}. As q depends on the position of the stationary point tₚ as well as the phase centers sᵢ and sⱼ, the samples of ^{˜}χ(q) required are determined by the geometry of the antenna and target positions. Physically, this is because the available Fourier space that may be sampled of the target is determined by this geometry, and therefore one may not arbitrarily choose the Fourier space support of the object. Interpolation must also be performed to calculate ^{˜} [symbol] (⋅) as these are also sampled on a uniform grid, and the frequencies

$$\frac{- {k}_{d} ( {t}_{p} - Δ {s}_{ij} )}{\vert {t}_{p} - Δ {s}_{ij} \vert} and \frac{- {k}_{d} ( {t}_{p} + Δ {s}_{ij} )}{\vert {t}_{p} + Δ {s}_{ij} \vert}$$

do not necessarily correspond to these samples, for example using a nearest neighbor or bilinear interpolator.

Algorithm 1 Forward operator

| | |
|---|---|
| 1: | P_{ijd} ← 0. |
| 2: | Take the 3-D discrete Fourier transform of χ_{abc} to yield \tilde{χ}_{abc}. |
| 3: | for all antenna pairs i, j, stationary points tₚ and frequencies k_{d} do |
| 4: | $Calculate q = {k}_{d} \frac{{t}_{p} - Δ {s}_{ij}}{\vert {t}_{p} - Δ {s}_{ij} \vert} + \frac{{t}_{p} + Δ {s}_{ij}}{\vert {t}_{p} + Δ {s}_{ij} \vert} - {q}_{0}$ |
| 5: | Calulate |
| | ${P}_{ijd} ← {P}_{ijd} + \tilde{𝒳} ( q ) \frac{- {k}_{d}}{2 {π}^{3 / 2} {η}_{0}}$ |
| | ${\tilde{p}}_{i} ( \frac{- {k}_{d} ( {t}_{p} - Δ {s}_{ij} )}{\vert {t}_{p} - Δ {s}_{ij} \vert} ; k ) {\tilde{p}}_{j} ( \frac{- {k}_{d} ( {t}_{p} + Δ {s}_{ij} )}{\vert {t}_{p} + Δ {s}_{ij} \vert} ; k )$ |
| | $exp [ i ( {r}_{0} - {t}_{p} - \frac{{s}_{i} + {s}_{j}}{2} ) \cdot ( q + {q}_{0} ) + {ik}_{d} ( \vert {t}_{p} - Δ {s}_{ij} \vert + \vert {t}_{p} + Δ {s}_{ij} \vert ) ]$ |
| | \|det H\|^{-1/2} (\|tₚ − Δsᵢⱼ\| + \|tₚ + Δsᵢⱼ\|)⁻² |
| 6: | end for |

The adjoint operator is somewhat more complicated because of the interpolation step. The linear operation corresponding to the adjoint is given by

$${}^{∼} χ ( q ) = {\sum }_{i ; j ; {t}_{p} ; {k}_{d}} \frac{- {k}_{d}}{2 {π}^{3 / 2} {η}_{0}} {P}_{ijd} {i}_{} {( \frac{- {k}_{d} ( {t}_{p} - Δ {s}_{ij} )}{\vert {t}_{p} - Δ {s}_{ij} \vert} ; k )}^{*} {{\sim}^{}}_{j} {( \frac{- {k}_{d} ( {t}_{p} + Δ {s}_{ij} )}{\vert {t}_{p} + Δ {s}_{ij} \vert} ; k )}^{*} exp [ - i ( {r}_{0} - {t}_{p} - \frac{{s}_{i} + {s}_{j}}{2} ) ( q + {q}_{0} ) - {ik}_{d} ( \vert {t}_{p} - {Δs}_{ij} \vert + \vert {t}_{p} + {Δs}_{ij} \vert ) ] {\vert det H \vert}^{- 1 / 2} {( \vert {t}_{p} - {Δs}_{ij} \vert \vert {t}_{p} + {Δs}_{ij} \vert )}^{- 2} \qquad ( 22 )$$

In practice, one would like to calculate ^{˜}χ(q) on a uniform grid to apply the inverse 3-D Fourier transform to recover χᵢⱼₖ. However, as noted during calculation of the forward operator, the samples of Fourier data depend on the stationary point and target, positions and therefore are generally not sampled uniformly. While for the forward operator, samples of the Fourier data may be interpolated, for the adjoint operator the samples, must be updated. As the samples are stored on a uniform grid, a method is needed to update the samples on a uniform grid given updates of spatial frequencies q that do not correspond to samples on the grid. This operation may be seen as the adjoint operation of the interpolation step. An interpolator takes a weighted sum of samples surrounding a spatial frequency to produce an estimate of the susceptibility at that spatial frequency. To update a spatial frequency using the adjoint of the interpolation step, one adds the weighted susceptibility at that spatial frequency to the samples that determined the susceptibility to be updated. As interpolators generally apply the largest magnitude weights to samples nearest to the interpolated point, the adjoint of the interpolator adds the largest contribution of the interpolated points to samples near the point.

In practice, this may be achieved by updating two arrays, a cumulative array of samples ^{˜}χ′_{abc} in the Fourier space, and a corresponding cumulative array of weights w_{abc}. The cumulative array of weights accounts for the contributions of each updated point to a given sample. The function W(q,qᵣ) is the magnitude of the weight of a point at qᵣ to a sample at point q, which is usually a decreasing function of |q−qᵣ|. The pseudocode of the algorithm to implement the adjoint operator using the cumulative array of weights to perform the adjoint interpolation step is:

Algorithm 2 Adjoint operator

| | |
|---|---|
| 1: | \tilde{χ}_{abc}^{′} ← 0, w_{abc} ← 0. |
| 2: | for all antenna pairs i, j, stationary points tₚ and |
| | frequencies k_{d} do |
| 3: | $Calculate q = {k}_{d} \frac{{t}_{p} - Δ {s}_{ij}}{\vert {t}_{p} - Δ {s}_{ij} \vert} + {k}_{d} \frac{{t}_{p} + Δ {s}_{ij}}{\vert {t}_{p} + Δ {s}_{ij} \vert} - {q}_{0}$ |
| 4: | $Calculate a = round ( \frac{q \cdot \hat{x}}{Δ {q}_{x}} ) , b = round ( \frac{q \cdot \hat{y}}{Δ {q}_{y}} ) , and$ |
| | $c = round ( \frac{q \cdot \hat{z}}{Δ {q}_{z}} ) with round being the nearest interger$ |
| | function. |
| 5: | Calculate qᵣ = aΔqₓ\hat{x} + bΔq_{y}ŷ + cΔq_{z}\hat{z} |
| 6: | Accumalate susceptibility |
| | ${\tilde{χ}}_{abc}^{′} ← {\tilde{χ}}_{abc}^{′} + W ( q , {q}_{r} ) {P}_{ijd} \frac{- {k}_{d}}{2 {π}^{3 / 2} {θ}_{\text{?}}}$ |
| | ${\tilde{ρ}}_{i} {( \frac{- {k}_{d} ( {t}_{p} - Δ {s}_{ij} )}{\vert {t}_{p} - Δ {s}_{ij} \vert} ; k )}^{*} {\tilde{ρ}}_{j} {( \frac{- {k}_{d} ( {t}_{p} + Δ {s}_{ij} )}{\vert {t}_{p} + Δ {s}_{ij} \vert} ; k )}^{*}$ |
| | $exp [ - i ( {r}_{0} - {t}_{p} - \frac{{s}_{i} + {s}_{j}}{2} ) \cdot ( q + {q}_{0} ) -$ |
| | ik_{d}(\|tₚ − Δsᵢⱼ\| + \|tₚ + ΔSᵢⱼ\|)] |
| | \|det H\|^{-1/2} (\|tₚ − Δsᵢⱼ\| \|tₚ + Δsᵢⱼ\|)⁻² |
| 7: | Accumulate weights w_{abc} ← w_{abc} + W (q, qᵣ) |
| 8: | end for |
| 9: | Divide weights \tilde{χ}_{abc} ← \tilde{χ}_{abc}^{′}/w_{abc}, with the case 0/0 = 0. |
| 10: | Take the inverse 3-D discrete Fourier transform of \tilde{χ}_{abc} |
| | to yield χ_{abc}. |

$\text{?} \text{indicates text missing or illegible when filed}$

The sampling of stationary points tₚ must be sufficiently dense to ensure that all points ^{˜}χ_{abc} are updated within the Fourier support of the object at least once.

One of the practical benefits of the algorithms disclosed herein is the correspondence of operations to those accelerated by GPGPU hardware. Because many of the operations on the sampled susceptibility and antenna functions are similar to those already designed into GPGPU hardware, especially texture mapping, texel retrieval, and projection operations, the same hardware logic that is used to retrieve and cache textures may be used to retrieve and cache antenna radiation patterns and the sample susceptibility. The plane-wave components of the antenna radiation patterns may be retrieved and projected in the same way rays are rendered to the computer display by the GPU, with the main difference being that while rays for display are represented by a vector of color channel values (e.g. red, green, blue, and alpha), the representation of the field amplitude of a plane-wave component is a floating-point complex number. As modern GPGPU hardware internally represents quantities using floating point arithmetic, the texture mapping hardware is easily adapted to representing the plane-wave representation of an electromagnetic field.

One of the practical benefits of the algorithms described in IMPLEMENTATION OF FAMI section is the correspondence of operations to those accelerated by GPGPU hardware. Because many of the operations on the sampled susceptibility and antenna functions are similar to those already designed into GPGPU hardware, especially texture mapping, texel retrieval, and projection operations, the same hardware logic that is used to retrieve and cache textures may be used to retrieve and cache antenna radiation patterns and the sample susceptibility. The plane-wave components of the antenna radiation patterns may be retrieved and projected in the same way rays are rendered to the computer display by the GPU, with the main difference being that while rays for display are represented by a vector of color channel values (e.g. red, green, blue, and alpha), the representation of the field amplitude of a plane-wave component is a floating-point complex number. As modern GPGPU hardware internally represents quantities using floating point arithmetic, the texture mapping hardware is easily adapted to representing the plane-wave representation of an electromagnetic field.

Examining this correspondence further, during the display of three-dimensional objects, GPGPU hardware projects polygons to the display by traversing a list of visible points on the surface of each polygon, retrieving the corresponding texel to each point, and then overlaying the retrieved texels with the pixels already on the display. The forward and adjoint operations have a similar structure. Instead of the traversed points being the visible points on the polygonal surfaces of the object, the stationary points tₚ correspond to the front surface of the object to be reconstructed. The “display” to which the results are accumulated corresponds to Pᵢⱼ(k) for the forward operation, or ^{˜}χ(q) for the adjoint operation. The textures from which texels are retrieved correspond to the plane-wave representation of the antenna radiation patterns. The implementation of the forward and adjoint operators is similar to the pixel processing pipeline already present in the GPGPUs.

Therefore in order to advantageously use the GPGPU pixel processing pipeline components to accelerate FAMI, one should put the antenna far-field radiation pattern samples ^{˜} [symbol] _{nm,ij} into 3-D textures as a function of plane-wave component indices n and m and frequency i, with the far-fields for each antenna j in separate textures. As the texture units are designed to cache texels based on their proximity to each other in the texture, and typical access patterns of FAMI tend to sequentially retrieve samples that are near each other in space and frequency, the caching of the antenna radiation patterns as texels results in fewer cache misses during texel retrieval. As the penalty for a cache miss is high for modern GPGPUs, it is crucial to tailor the memory access patterns to best exploit the cache. Furthermore, the input vectors, which are ^{˜}χ(q) for the forward operator, and Pᵢⱼ(k) for the adjoint operator, may also be stored in textures to improve the caching of these as well.

Because of the superposition principle of the forward and adjoint linear operators, the computation may be parceled to multiple GPGPU units and the result of the calculations of each GPGPU summed to yield the final result. This is analogous to how the Scalable Link Interface (SLI) is used to render graphics to the same display using multiple GPGPUs. The work of computing the operator for different antenna pairs i and j may be distributed to different GPGPUs. By having each GPGPU operate on different antenna pairs, the memory cache in the GPGPU can be dedicated to accelerating access to only the antenna radiation patterns needed for its portion of the computation. As the speed of computation is usually limited by the available memory bandwidth rather than the number of available compute units, one of the main benefits of using multiple GPGPU units is that each has an independent memory bus that can simultaneously access and cache its own copy of the antenna radiation patterns. Because FAMI is embarassingly parallelizable if different antenna patterns may be distributed to different compute units, the computation speed tends to scale well with added GPGPUs, with the limitations in scaling dominated by the need to distribute and retrieve the results of computations. For real-time applications, the communication between the GPGPUs must be carefully designed as to minimize the latency as the latency may begin to dominate the reconstruction time.

To implement and demonstrate FAMI, the algorithm was programmed as NVIDIA CUDA 8.0 and C++. The implementation of FAMI closely follows the examples provided herein. The GPGPU hardware includes four NVIDIA Geforce GTX 1080 graphics processors in a SLI configuration, which were contained in an Intel Core i7-5930K CPU personal computer with 128 gigabytes of random access memory (RAM). The software is interfaced to as a MATLAB MEX file. The compilation used Visual Studio 2013 under Windows 7, and GCC 4.8.4 under Linux 3.13 as well as the nvcc CUDA 8.0 compiler. As the typical speed of the adjoint image formation process is less than 200 ms, the latency introduced by MATLAB is a significant component of the processing time, however, MATLAB was used because it is a convenient platform for prototyping numerical algorithms. It is likely that a real-time practical implementation would not use MATLAB.

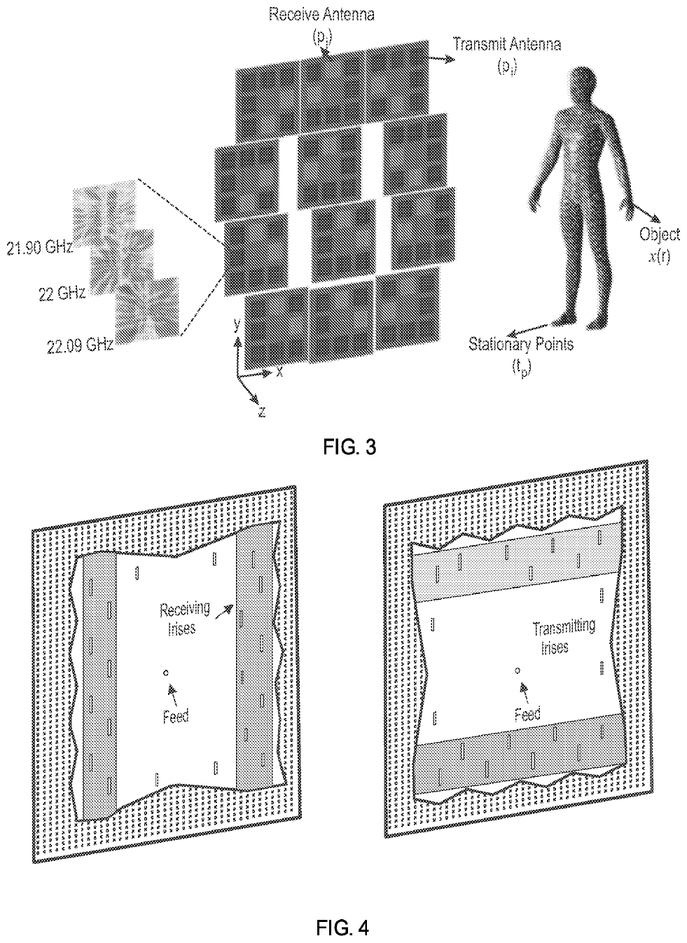

The simulated system has been described previously, a diagram of which is shown in FIG. 3. Briefly summarized, the system consists of 24 transmit antennas and 72 receive antennas, operated at 100 uniformly spaced frequencies between 17 and 26 GHz. Each of the 24 transmit antennas is nearly identical and produces similar radiation patterns as frequency is varied, and the 72 receive antenna produces radiation patterns nearly identical to each other but different than that of the transmit antennas. The antennas are high Q planar resonators that have radiating apertures on them in a Mills cross array pattern, with two 8 cm long rows of apertures oriented horizontally and separated by 8 cm vertically on the transmit antennas, and two 8 cm long columns of apertures oriented vertically and separated by 8 cm horizontally on the receive antennas. The apertures on all antennas are vertically oriented slots as to primarily transmit and receive in the vertical polarization so that a scalar approximation to the electromagnetic field may be used which corresponds to the electric response and material susceptibility in the vertical direction. Due to the irregular cavity shape of the transmit and receive antennas, the phase and amplitude of the radiation from the apertures varies in a fixed, pseudorandom pattern as the frequency is varied. The strong variation in radiation pattern with frequency enables frequency-diversity imaging techniques to be used with this system. A diagram of the antennas is shown in FIG. 4.

The antennas are arranged on a planar surface 2 m by 2 m in size. The object is nominally 1.3 m from the antenna surfaces. The far-field distance from each antenna is 0.85 m, so the object is in the radiation zone of all the antennas. The depth of field of the 2 m by 2 m aperture is approximately 13 mm, so that the best image is formed within about one wavelength from the surface of the stationary phase points. The layout of the transmit and receive antennas is shown in FIG. 3. This particular geometry of transmit and receive antennas is designed for security checkpoint scanning and therefore as a test object we chose a model of a human form to test FAMI. A mesh of uniformly scattering susceptibility points are placed on the surface of the human form to model the skin surface reflectivity. As flesh is largely reflective at the frequencies used, the reconstruction should be close to the subject's surface, and therefore the stationary points should be placed near the skin. This surface may be located approximately in practice by using a machine vision system to illuminate the subject and determine the shape of the visible surface which is meshed into a list of stationary points.

A couple of modifications were made to the algorithm to produce a reconstruction similar to the previous Virtualizer software. First, the factor of |detH|^{-1/2} in Eq. 20 that accounts for the relative orientation of the stationary point to the transmit and receive antennas is changed to |detH|^{1/2} in the forward and adjoint operators. When the −½ exponent is used, the Hessian factor is singular when the transmit and receive antennas are nearly colocated, which produced singular features on the stationary phase surface. As an inverse of the forward operator would tend to compensate for the Hessian factor, the reciprocal of the Hessian factor, the ½ exponent, was applied instead. A second improvement takes advantage of the fact that the objects are surface objects, and therefore scattering points tend to be near other scattering points. After the adjoint operation was calculated, an “envelope function” was applied that convolves the magnitude of the susceptibility of the object with a Gaussian kernel:

$${χ}_{E} ( r ) = \frac{2}{{( 2 π {r}_{0} )}^{3 / 2}} {\int }_{V} \vert χ ( {r}^{′} ) \vert exp ( - \frac{{\vert {r}^{′} - r \vert}^{2}}{2 {r}_{0}^{2}} ) {d}^{3} {r}^{′} \qquad ( 23 )$$

where r₀ is a window size, usually a few resolution cells in width. The susceptibility χ(r) is then multiplied by this envelope function χ_{E}(r), and then normalized to have the same squared magnitude signal as before multiplying by the envelope function. The effect of this nonlinear filter is to prefer points with high magnitude that are near other points, and suppress others. For surface objects, this filter greatly reduces the noise and concentrates energy onto a surface.

To serve as a benchmark for FAMI's performance, the Virtualizer, a tool for the simulation and reconstruction of coherent images that performs Eq. 3 directly, which is also optimized for GPGPU acceleration, is used. Unlike the FAMI implementation, the Virtualizer code does not take advantage of multiple GPUs for computation. To reconstruct the target, the Virtualizer performs the sum of Eq. 3 for each point to be reconstructed in a volume. The volume conforms to the surface of the target and extends in range several wavelengths away from the target towards the antenna array. The Virtualizer creates a lookup table and partitions the volume to efficiently store the three-dimensional radiation patterns of the antennas at each frequency for rapid retrieval to minimize GPGPU memory bandwidth consumption. On the other hand, the sum of Eq. 20 need only be performed over the surface of stationary points on the surface of the target rather than in a volume, but the volume is reconstructed near this surface. Only the far-field radiation patterns of the antennas need to be stored, rather than three-dimensional radiation patterns. For FAMI, the stationary points on the surface of the target were placed in a rectangular grid at half a wavelength, or 7.5 mm, intervals. To reconstruct the edges of the object, the surface of the stationary points must be extended 3 to 4 wavelengths beyond the edge in order that constructive interference occurs on the surface at the boundary and destructive interference outside the boundary, so that the reconstruction on the surface is well-defined.

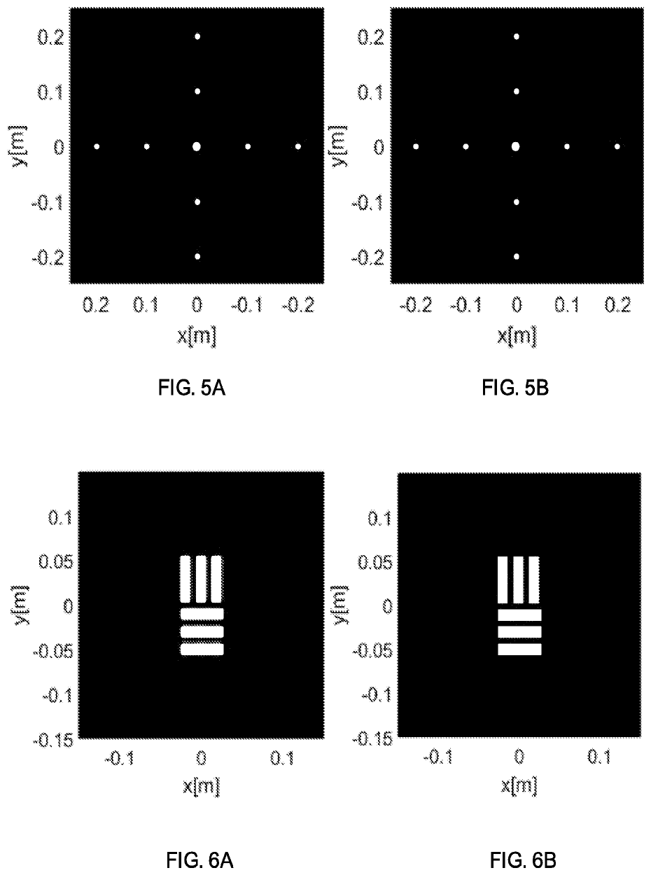

For comparison, initially a simple target, consisting of an array of point-scatters seperated by a distance of 10 cm from each other in the cross-range, may be imaged. Imaging of the point-scatter target is important in that it enables the analysis of the transfer function of the system by means of the point spread function (PSF). For image reconstruction, least-squares technique is used. The least-squares solution is 5 iterations of the conjugate gradient algorithm applied to the normal equations, with each iteration applying the forward and adjoint operators once for both the Virtualizer and FAMI, the results of which are shown in FIGS. 5A and 5B.

Analyzing the reconstructed images in FIGS. 5A and 5B, it is evident that both reconstructions are similar. The full-width-half-maximum (FWHM) values for the Virtualizer and FAMI reconstructions are obtained to be 5.02 mm and 5.06 mm, respectively. A significant advantage of the FAMI algorithm can be appreciated when the reconstruction times are compared. While the Virtualizer reconstruction takes 5.71 s, the FAMI completes the reconstruction in 0.2 s, corresponding to a speed-up by a factor of 96.5% when compared to the Virtualizer.

Following the imaging of the multi-point scatter target, imaging of a 1 cm resolution target is performed. Similar to the point scatter target, the least-squares technique is used for image reconstruction (5 iterations). The Virtualizer and FAMI reconstructed images of the resolution target are shown in FIGS. 6A and 6B.

Analyzing FIGS. 6A and 6B, it can be seen that both the Virtualizer and the FAMI reconstruct a clear outline of the resolution target. While the Virtualizer reconstruction takes 9.21 s, the FAMI completes the reconstruction in 0.28 s, 97% faster in comparison to the Virtualizer. A comparison between the Virtualizer and FAMI reconstruction times for the multi-point scatter and 1 cm resolution targets is given in Table 3. It should be noted here that both the multi-point scatter target in FIGS. 5A and 5B and the resolution target in FIGS. 6A and 6B are 2D planar targets defined in the cross-range plane. As a more realistic and complicated target, finally, we image an object of human form, which extends in both the range and cross-range planes (3D).

TABLE 3
Summary of timing of algorithms for reconstruction of 2D
targets (least-squares reconstruction, 5 iterations).

| Target | Virtualizer | FAMI |
|---|---|---|
| Point Scatter | 5.71 s | 0.2 s |
| Resolution Target | 9.21 s | 0.28 s |

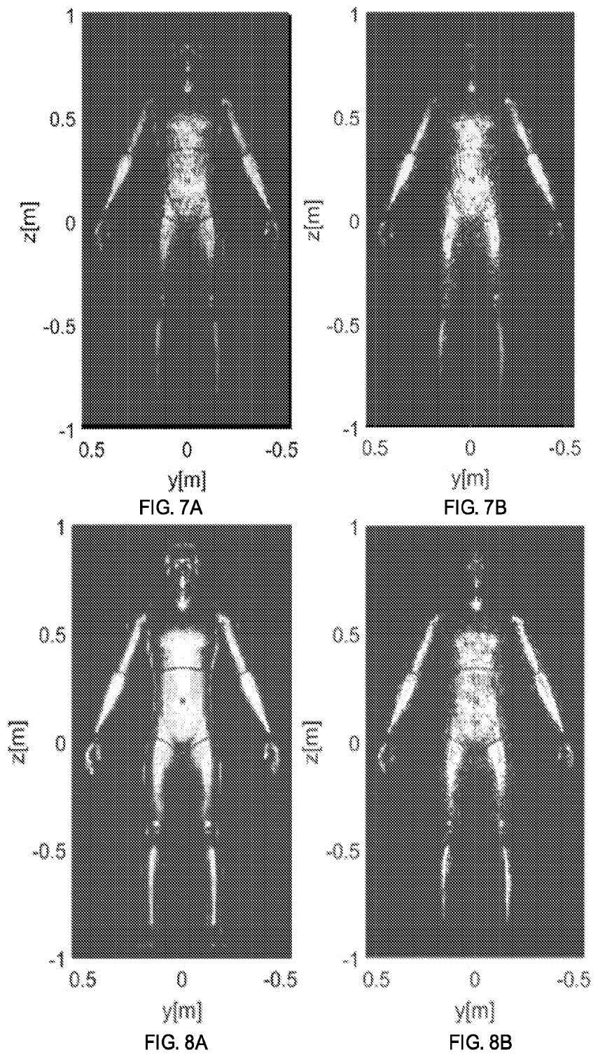

For this analysis, different from the 2D targets, two reconstruction methods are used; matched-filter (adjoint operation) and least-squares (adjoint and forward operations). The reconstruction of the human form target using just the adjoint operation is shown in FIGS. 7A and 7B. The two reconstructions look very similar, however, FAMI required 0.28 s rather than 7.2 s to perform the adjoint operation when compared to the Virtualizer. The least-squares solution (5 iterations) is demonstrated in FIGS. 8A and 8B. FAMI completes the reconstruction in 2.6 s, while the Virtualizer completes the task in 121.7 s, so that FAMI requires 2.1% of the time. A summary of timings is given in Table 4.

TABLE 4
Summary of timing of algorithms for reconstruction
of the human form target.

| Calculation Step | Virtualizer | FAMI |
|---|---|---|
| Adjoint Reconstruction | 7.2 s | 0.28 s |
| Least-SquaresReconstruction (5 iterations) | 121.7 s | 2.6 s |

In short, FAMI is a multi-static radar imaging algorithm that is able to adapt to large separations between transmitters and receivers and highly irregular radiation patterns. It is readily parallelizable, and adaptable to GPGPU processing as it can utilize built-in features such as texture mapping to accelerate computation.

The present subject matter may be a system, a method, and/or a computer program product. The computer program product may include a computer readable storage medium (or media) having computer readable program instructions thereon for causing a processor to carry out aspects of the present subject matter.

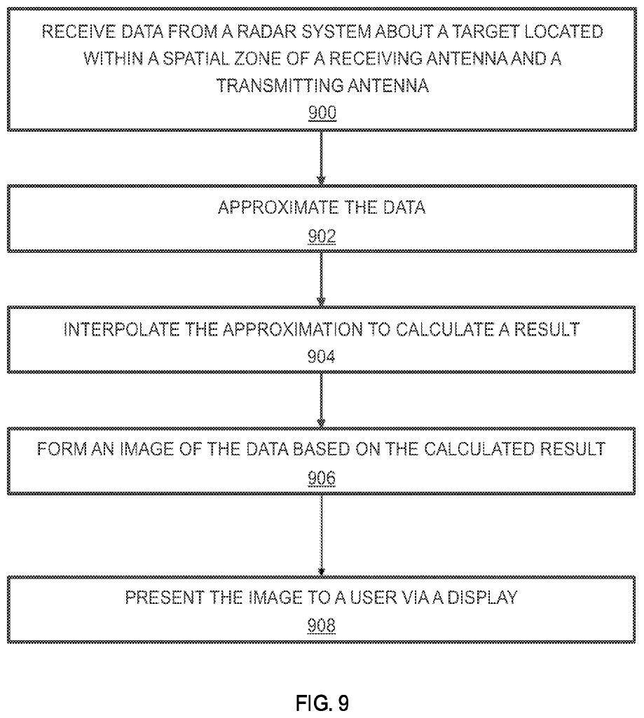

In accordance with an embodiment of the present application, FIG. 9 illustrates a flow chart of an example method for multiple-input-multiple-output (MIMO) imaging for performing massively parallel computation in accordance with embodiments of the present disclosure. With continuing reference to FIG. 9, the method includes receiving 900 data from a radar system about a target located within a spatial zone of a receiving antenna and a transmitting antenna. The method further includes approximating 902 the data. The method further includes interpolating 904 the approximation to calculate a result. The method further includes forming 906 an image of the data based on the calculated result. Lastly, the method includes presenting 908 the image to a user via a display.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, a server. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a computing device:
receiving data from a radar system about a target located within a spatial zone of a receiving antenna and a transmitting antenna;
approximating the data;
interpolating the approximation to calculate a result;
forming an image of the data based on the calculated result; and
presenting the image to a user via a display.

2. The method of claim 1, wherein the computing device is configured to perform rapid parallel computations, the computing device comprises one of a digital computer and a highly parallel processor.

3. The method of claim 1, wherein the computing device is a general-purpose graphics processing unit (GPGPU).

4. The method of claim 1, wherein the radar system is a multiple-input-multiple-output (MIMO) radar system comprising one of a frequency diverse transmitting and receiving antenna.

5. The method of claim 1, wherein the spatial zone is a radiation zone located far-field from the receiving and transmitting antennas.

6. The method of claim 1, wherein receiving data comprises receiving a synchronized radiation field of the target obtained from a multiple-input-multiple-output (MIMO) radar system comprising at least one of a frequency diverse transmitting and receiving antenna.

7. The method of claim 1, wherein receiving data comprises translating the data regarding the target location onto a common coordinate system.

8. The method of claim 1, wherein approximating the data comprises:
applying a Fast Fourier Transform (FFT) algorithm to generate a scalar approximation of the data; and
determining a principal model of the radar system via a first-scattering approximation.

9. The method of claim 8, wherein determining a principal model comprises:
determining a radiation field of a target via data from a transmitter;
modeling the first-scattering approximation of the target as given by a product of an incident field on the target and a susceptibility of the target; and
measuring a scattered radiation of the target at a receiving antenna as characterized by a phase and amplitude of a receiving wave.

10. The method of claim 1, wherein approximating the data comprises:
calculating a forward operator relating to a measurement of a target susceptibility; and
calculating an adjoint operator relating to a backpropagation of the measurement of the target susceptibility.

11. The method of claim 1, wherein interpolating the approximation comprises interpolating a forward operator and updating an adjoint operator.

12. The method of claim 1, wherein interpolating the approximation comprises:
creating a lattice of sampled spatial frequencies;
finding a location within the lattice that contains a desired spatial frequency corresponding to a desired stationary point;
determining whether the desired spatial frequency is on the lattice; and
in response to determining that the desired spatial frequency is not on the lattice, obtaining the desired spatial frequency by interpolating a plurality of adjacent samples on the lattice surrounding the desired spatial frequency.

13. The method of claim 12, wherein obtaining the desired spatial frequency comprises:
determining a weighted sum from the plurality of adjacent samples;
producing a weighted estimate of a susceptibility at the desired spatial frequency derived from the weighted sum; and
in response to producing the weighted estimate, calculating the forward operator via interpolation.

14. The method of claim 12, wherein obtaining the desired spatial frequency comprises:
determining a weighted sum from the plurality of adjacent samples;
producing a weighted estimate of a susceptibility at the desired spatial frequency derived from the weighted sum;
adding the weighted estimate of the susceptibility at the desired spatial frequency to the weighted sum of the plurality of adjacent samples; and
in response to adding the weighted estimate, updating the adjoint operator.

15. The method of claim 1, further comprising:
approximating the data locally using a plane wave component incident from the receiving antenna and captured by the transmitting antenna; and
in response to approximating the data locally using the plane wave component, determining a plurality of spatial frequencies of the data.

16. The method of claim 15, wherein determining the plurality of the spatial frequencies of the data comprises:
determining a coronal surface of a plurality of stationary points aligned with the cross-range direction of a target volume; and
summing over the coronal surface of the plurality of stationary points.

17. A computing device comprising:
at least one processor and memory configured to:
receive data from a radar system about a target located within a spatial zone of a receiving antenna and a transmitting antenna;
approximate the data;
interpolate the approximation to calculate a result;
form an image of the data based on the calculated result; and
present the image to a user via a display.

18. The computing device of claim 17, wherein the computing device is configured to perform rapid parallel computations, and comprises one of a digital computer and a highly parallel processor.

19. The computing device of claim 17, wherein the computing device is a general-purpose graphics processing unit (GPGPU).

20. The computing device of claim 17, wherein the radar system is a multiple-input-multiple-output (MIMO) radar system comprising one of a frequency diverse transmitting and receiving antenna.

21. The computing device of claim 17, wherein the spatial zone is a radiation zone located far-field from the receiving and transmitting antennas.

22. The computing device of claim 17, wherein the at least one processor and memory are configured to receive a synchronized radiation field of the target obtained from a multiple-input-multiple-output (MIMO) radar system comprising at least one of a frequency diverse transmitting and receiving antenna.

23. The computing device of claim 17, wherein the at least one processor and memory translate the data regarding the target location onto a common coordinate system.

24. The computing device of claim 17, wherein the at least one processor and memory are configured to:
apply a Fast Fourier Transform (FFT) algorithm to generate a scalar approximation of the data; and
determine a principal model of the radar system via a first-scattering approximation.

25. The computing device of claim 24, wherein the at least one processor and memory are configured to:
determine a radiation field of a target via data from a transmitter;
model the first-scattering approximation of the target as given by a product of an incident field on the target and a susceptibility of the target; and
measure a scattered radiation of the target at a receiving antenna as characterized by a phase and amplitude of a receiving wave.

26. The computing device of claim 17, wherein the at least one processor and memory are configured to:
calculate a forward operator relating to a measurement of a target susceptibility; and
calculate an adjoint operator relating to a backpropagation of the measurement of the target susceptibility.

27. The computing device of claim 17, wherein the at least one processor and memory are configured to interpolate a forward operator and updating an adjoint operator.

28. The computing device of claim 17, wherein the at least one processor and memory are configured to:
create a lattice of sampled spatial frequencies;
find a location within the lattice that contains a desired spatial frequency corresponding to a desired stationary point;
determine whether the desired spatial frequency is on the lattice; and
obtain the desired spatial frequency by interpolating a plurality of adjacent samples on the lattice surrounding the desired spatial frequency in response to determining that the desired spatial frequency is not on the lattice.

29. The computing device of claim 28, wherein the at least one processor and memory are configured to:
determine a weighted sum from the plurality of adjacent samples;
produce a weighted estimate of a susceptibility at the desired spatial frequency derived from the weighted sum; and
calculate the forward operator via interpolation in response to producing the weighted estimate.

30. The computing device of claim 28, wherein the at least one processor and memory are configured to:
determine a weighted sum from the plurality of adjacent samples;
produce a weighted estimate of a susceptibility at the desired spatial frequency derived from the weighted sum;
add the weighted estimate of the susceptibility at the desired spatial frequency to the weighted sum of the plurality of adjacent samples; and
update the adjoint operator in response to adding the weighted estimate.

31. The computing device of claim 17, wherein the at least one processor and memory are configured to:
approximate the data locally using a plane wave component incident from the receiving antenna and captured by the transmitting antenna; and
determine a plurality of spatial frequencies of the data in response to approximating the data locally using the plane wave component.

32. The computing device of claim 31, wherein the at least one processor and memory are configured to:
determine a coronal surface of a plurality of stationary points aligned with the cross-range direction of a target volume; and
sum over the coronal surface of the plurality of stationary points.
